(19) United States
(12) Patent Application Publication
(10) Pub. No.: US 2025/0371882 A1
(43) Pub. Date: Dec. 4, 2025

(54) CAMERA DEVICE AND METHOD FOR MONITORING AND/OR CONTROLLING A WORK PROCESS IN A WORKING ENVIRONMENT

(71) Applicant: SICK AG, Waldkirch (DE)

(72) Inventors: Govinda KEMPERMANN, Gutach im Breisgau (DE); Jan GERBER, Sexau (DE); Josef BAAK, Waldkirch (DE)

(21) Appl. No.: 19/221,388

(22) Filed: May 28, 2025

(30) Foreign Application Priority Data
May 29, 2024 (EP) 24178728.2

(51) Int. Cl. G06V 20/52; G06V 10/25; G06V 10/26; G06V 10/36; G06V 10/82; H04N 5/91; H04N 23/61

(52) U.S. Cl. CPC G06V 20/52; G06V 10/25; G06V 10/26; G06V 10/36; G06V 10/82; H04N 5/91; H04N 23/61

(57) ABSTRACT

The invention relates to a camera apparatus and to a method for monitoring and/or controlling a work sequence in a working environment. The camera apparatus comprises at least one image sensor in which a plurality of picture elements are arranged and which is configured to record a sequence of image data of at least one region of the working environment, wherein the recording of the image data takes place continuously at a presettable or preset frame rate during the work sequence, the camera apparatus furthermore comprises at least one detection unit that is configured to detect one or more objects in the image data, and at least one control unit that is configured to control image recording parameters of the at least one image sensor, wherein the detection unit is configured to determine a region of interest on the basis of the objects detected in the image data, wherein the control unit is configured to control, in particular to adaptively change, at least one image recording parameter on the basis of the region of interest determined by the detection unit, and wherein the at least one image recording parameter comprises a cropping parameter that limits the recording of image data by the image sensor to an image section that corresponds to the region of interest.

The invention relates to a camera apparatus and to a method for monitoring and/or controlling a work sequence in a working environment.

In stationary applications and work sequences in which the conditions change continuously over time, for example when palletizing and depalletizing goods or packages, 2D and/or 3D sensor systems mounted in a stationary manner are often used to recognize and to segment and, if necessary, to classify the goods or packages on belts and pallets and to determine the best gripping coordinate for a robot arm. The sensors are, for example, 3D time-of-flight (ToF) cameras or 3D stereo cameras whose depth information is supported by data from 2D RGB cameras. The 2D and/or 3D cameras are usually arranged in a stationary manner above the pallet, for example at a height of 4 m above the pallet base, and provide a sequence of image data in order to recognize goods and packages on the pallet and, for example, to transmit the gripping coordinates for a gripping process to a robot.

During a work process such as palletizing or depalletizing, the relevant image section, generally also known as the “region of interest” (ROI), changes depending on the height of the goods or packages on the pallet. Furthermore, the quality of the 2D and 3D data can change with the stack height, but also due to time-varying influences such as a changing environmental light or a changing type of goods on the pallet. Thus, at greater distances between the sensor and the recorded object, the accuracy of the 3D data is lower than at smaller distances and the 2D image is sharper and brighter in bright environments than in darker ones.

Here, in addition to the relevant image section, the resolution available in the respective image section also changes during such a work process. However, many algorithms for segmentation and classification and in particular neural networks work best on input images with a fixed and known resolution.

For an interruption-free work sequence, recording parameters of the sensors or cameras, such as spatial and temporal filters or the exposure time, are often statically configured for a working environment at the beginning so that they can work as effectively as possible under all possible conditions, such as a changing environmental brightness or changing distances of the objects to be recorded. The sensors are usually configured such that they always record the same image section defined by the user at the start of the work process.

This static image section is usually selected so large that the entire pallet is always recorded and imaged during the work process. However, such a large image section is not always necessary, for example, if the maximum stack height is reached during the work sequence. Thus, some superfluous data are generated that must all be output via an interface of the sensor and transferred to a central processing unit for data processing.

In particular with high-resolution sensors such as 3D sensors having more than, for example, 0.2 MP or 2D sensors having more than 5 to 10 MP, a large transmission architecture with a high bandwidth is required. At the destination, the transmitted image data are then often compressed to a fixed target size for the processing, i.e., for example, for the segmentation or classification, by cropping and binning since algorithms and in particular neural networks work best with a fixed, rather smaller resolution of the image data.

In previous stationary applications and work sequences, a high bandwidth of the data transmission is thus both necessary and utilized. The transmission and processing of the large data volume has the disadvantage of additional latency, on the one hand, but can also lead to bandwidth-related limitations of the sensors, on the other hand. For example, a limitation of the bandwidth may require a limitation of the resolution of the transmitted image data. Furthermore, the necessary transmission architecture, for example a 10 Gbit Ethernet architecture, and the further processing on a central processing unit can cause considerable costs.

In summary, it can thus be stated that the best possible data are not recorded by the static configuration of the sensors with fixed image recording parameters and filter settings, but rather a compromise that has to consider many possible conditions and thus does not provide optimal settings. For example, the 3D data can be too noisy at large distances, while said 3D data are too greatly spatially averaged at small distances.

It is therefore an object of the invention to provide an improved camera apparatus for monitoring and/or controlling a work sequence in a working environment that optimizes the quality and quantity of generated image data. It is a further object of the invention to specify an improved method for monitoring and/or controlling a work sequence in a working environment by a camera apparatus that enables a faster, more accurate and more cost-effective monitoring and/or control of the work sequence.

The object is satisfied in a first aspect of the invention by a camera apparatus having the features of claim 1 and in particular in that the camera apparatus comprises at least one image sensor in which a plurality of picture elements are arranged and which is configured to record a sequence of image data of at least one region of the working environment, wherein the recording of the image data takes place during the work sequence, preferably continuously at a presettable or preset frame rate, the camera apparatus furthermore comprises at least one detection unit that is configured to detect one or more objects in the image data and at least one control unit that is configured to control image recording parameters of the image sensor, wherein the detection unit is configured to determine a region of interest on the basis of the objects detected in the image data, wherein the control unit is configured to control, in particular to adaptively change, at least one image recording parameter on the basis of the region of interest determined by the detection unit, and wherein the at least one image recording parameter comprises a cropping parameter that limits the recording of image data by the image sensor to an image section that corresponds to the region of interest.

The camera apparatus serves to monitor and/or control a work sequence in a working environment, in particular a static working environment. In this application, the working environment is defined as a three-dimensional region that is required during the work sequence. The work sequence can here comprise a series of similar and/or different work steps.

The camera apparatus can have one image sensor or a plurality of image sensors that are each connected to their own associated control unit and/or their own associated detection unit. Alternatively, it can also be provided that, in a configuration of the camera apparatus having a plurality of image sensors, all the image sensors are associated with a single detection unit and a single control unit and are connected thereto.

A plurality of picture elements, often also referred to as resolution elements or pixels, are arranged in the image sensors, in particular in a matrix form. The image sensors can here be image sensors of a 3D camera, for example a time-of-flight camera (ToF) or a stereo camera, or also image sensors of a 2D camera, in particular a 2D RGB camera.

The camera apparatus is arranged in a stationary manner above, below or next to the working environment, and indeed such that the image sensor(s) can image the entire region of the working environment. The camera apparatus is configured to continuously record a sequence of image data of at least one region of the working environment during a work sequence at a preset or presettable frame rate. To achieve a complete time monitoring of the work sequence, it is expedient in this respect to carry out the presetting of the frame rate so that it is greater than the cycle rate of the work steps of the work sequence.

The detection unit is configured to detect objects in the image data, in particular by means of a neural network, and to determine a region of interest (ROI) within the working environment on the basis of the objects detected in the image data. For this purpose, the detection unit can, for example, be configured to determine an outer bounding contour of the objects detected in the image data and to use this contour to determine the region of interest.

Within the framework of the application, the region of interest is defined as that image section in the image data that comprises all the relevant objects detected in the working environment before the next work step and a sufficiently large adjoining marginal region. In the case of a palletizing, the region of interest from the angle of view of the image sensor is thus the entire surface of the pallet, of the load on the pallet and of a sufficiently large buffer environment to ensure that the load is always in the relevant image section.

The size of a region of interest can change during the work sequence, in particular continuously. For example, at the start of a palletizing process, the distance between the camera and the load already positioned on the pallet is relatively large, whereby a relatively small region of interest results. As the palletizing process progresses, the distance between the camera and the load already positioned on the pallet becomes continually smaller, which results in an ever larger region of interest.

The camera apparatus is now configured, using its own recorded image data, to continuously adaptively change the region of interest and at least one image recording parameter to be able to provide optimal image recording parameters for the changing recording requirements.

Here, at least the cropping parameter of the image recording is changed and the image recording is thus limited to an image section that corresponds to the changing region of interest. For example, neural networks or suitable algorithms can be used to recognize and to determine the image contour of a pallet together with its contents. Based on the recognized contour, a region of interest is determined, whereby a relevant image section is defined in which the pallet is reliably detected. The dimensions and limits of this contour are then saved as cropping parameters, whereby the recording is limited to a relevant image section that corresponds to the region of interest.

The camera apparatus is configured to adaptively change the recording parameters such that only a respective region of interest is always recorded during a work sequence. The recording of image data is thus adaptively limited to relevant image sections, while a recording of unnecessary image data is avoided. This reduces the volume of the image data to be transmitted and evaluated, reduces the latency time and enables cost-saving solutions in the data transmission architecture. At the same time, the transmitted image data are of high quality since only high-quality and relevant image data are generated.

In addition to the monitoring of palletizing sequences, the camera apparatus can also be used to monitor other work sequences. The bin picking with different fill levels, the monitoring of differently loaded conveyor belts including the segmentation or classification of the load located on the conveyor belt, the monitoring of assembly positions by means of a sensor arranged on a robot arm with the aim of holding a specific object in the region of interest in order to detect changes in the object, or also a detailed tracking of objects, can be named as examples here, wherein the region of interest follows the object in order to track the movement.

According to one embodiment of the invention, the control unit is configured to determine, in particular to adaptively change, the at least one image recording parameter for the next recording of image data on the basis of the region of interest determined by the detection unit in the image data of the previous recording. The camera apparatus is thus configured to generate image data and to transmit said image data to the detection unit that shows the current progress of the work process. In these current image data, the detection unit determines a region of interest that comprises all the relevant objects detected in the working environment before the next work step and a sufficiently large adjoining marginal region. Based on this current region of interest, image recording parameters for the next recording are now determined by the control unit. The image recording parameters are thus optimally set to or matched to the current situation and the current region of interest.

According to one embodiment of the invention, the resolution of the image data is constant and can be selected and/or preset between a minimum value and a maximum value. To select the resolution, an interface can, for example, be provided at the camera apparatus, via which interface the desired resolution can be entered. To provide the desired resolution, the camera apparatus is in particular configured to apply suitable algorithms, such as interpolation, to the image data. Here, the interpolation is preferably applied to image data with a higher resolution than the desired resolution, whereby a subsequent downsampling of the image data takes place.

The resolution can, for example, correspond to the resolution of the image data with which a neural network was trained for the subsequent segmentation of the image data. Algorithms and in particular neural networks work best on input images with a fixed, known resolution. By selecting a constant resolution that corresponds to the resolution of the training data, the accuracy of the solution calculated by the neural network can be improved and optimized.

According to one embodiment of the invention, the image recording parameters comprise a binning parameter that summarizes a number of adjacent picture elements of the image sensor. If, for example, the resolution of the image data in one dimension is too high by more than an integer factor F (2x, 4x, . . . ), the binning parameter is selected such that a number of adjacent pixels corresponding to the factor F is combined. Once the picture elements have been combined, the image data can be interpolated to the desired resolution. The combination of the picture elements can take place before the recording of image data or subsequent to the recording of image data, wherein picture elements of the recorded image data are combined accordingly.

With the binning of the image data, after the selection and/or setting of the constant resolution, it can be achieved that image data with a fixed image size can be recorded regardless of the size of the region of interest and can be fed to the further processing. The camera apparatus is consequently able to always output image data of the same size with the best possible information content about the region of interest. Thus, the camera apparatus always provides an optimal image as input data for the segmentation, for example for the neural network. A neural network works best with a fixed input variable that was also used during the training process of the neural network. Due to their equal image size, the recorded image data can be injected directly into the neural network without a further adaptation of the image size or a filling in of non-existent data. By setting a fixed image size, more precise information on the required bandwidth can also be provided and better estimates of the runthrough time for the actual work step can be made. Thus, an optimal balance between the number of data points in the image data and a maximum possible bandwidth can be achieved.

According to one embodiment of the invention, the image recording parameters comprise a spatial filter parameter that spatially averages the image data recorded by the image sensor. By adaptively changing the image recording parameters, it is possible to optimally configure the spatial filter parameters, for example based on the most recently acquired image data. The spatial filter parameter can be selected such that the best possible balance between a spatial repetition accuracy and an edge resolution is achieved. In the event of high requirements on the repetition accuracy, for example a repetition accuracy of better than 5 mm, a more pronounced spatial filtering may be necessary for large distances between the camera and the object. For this purpose, measurement values of adjacent picture elements can be weighted and averaged, for example. For bright objects or close distances, such an averaging can be omitted if necessary. The situation is similar for the activation or deactivation of functions such as HDR (High Dynamic Range) of the camera apparatus using multiple recordings.

According to one embodiment of the invention, the image recording parameters comprise a temporal filter parameter that temporally averages a sequence of image data consecutively recorded by the image sensor. By adaptively changing the image recording parameters, it is possible to optimally configure the temporal filter parameters, for example based on the most recently recorded image data. Similarly to the spatial filter parameter, the temporal filter parameter can be selected such that the best possible balance between the repetition accuracy and the edge resolution is achieved.

According to one embodiment of the invention, the image recording parameters comprise the exposure time for the recording of the image data by the image sensor. By adaptively changing the image recording parameters, it is possible to optimally configure the exposure time, for example based on the most recently recorded image data. The exposure time can, for example, change in dependence on the distance between the camera apparatus and the recorded object.

Environmental influences such as a changing environmental brightness can also make it necessary to adapt the exposure time.

According to one embodiment of the invention, the detection unit comprises a neural network that is configured to determine a region of interest on the basis of the objects detected in the image data. For example, the neural network can be configured to determine an outwardly bounding contour of the objects detected in the image data and to select the region of interest based on this contour. The neural network can, for example, be an object detection network or a segmentation network, such as R-CNN, Mask R-CNN, YOLO, SSD or Vision Transformer, that has been trained with sample images or simulated data of the detected objects.

According to a second aspect of the invention, the object is satisfied by a method for monitoring and/or controlling a work sequence in a working environment by a camera apparatus, wherein the camera apparatus comprises at least one image sensor, at least one detection unit and at least one control unit that is configured to control image recording parameters of the image sensor, wherein a plurality of picture elements are arranged in the image sensor and the image sensor records a sequence of image data of at least one region of the working environment, preferably continuously at a presettable or preset frame rate, the detection unit detects objects in the image data and determines a region of interest within the working environment on the basis of the objects detected in the image data, the control unit controls, in particular adaptively changes, at least one image recording parameter on the basis of the region of interest determined by the detection unit, and wherein the at least one image recording parameter comprises a cropping parameter that limits the recording of image data by the image sensor to an image section that corresponds to the region of interest.

According to an embodiment of the second aspect of the invention, the control unit determines, in particular adaptively changes, image recording parameters for the next recording of image data on the basis of the region of interest determined by the detection unit in the image data of the previous recording.

The image sensor in particular records the entire region of the working environment with a maximum resolution at the start of the method and stores the recording as a reference image. The maximum resolution corresponds to the best possible resolution of the image sensor of the camera apparatus. The reference image corresponds to a complete and accurate image of the working environment and provides a complete overview of the available space and the apparatus located therein. It is ensured by the reference image that no relevant image section is located outside the recorded region. The reference image serves to check and define the working environment at the start of the work sequence. Furthermore, the reference image can also be used for security purposes

The method according to the invention and its embodiments are carried out by means of the camera apparatus according to the invention or one of its embodiments. The statements on the camera apparatus and its embodiments apply accordingly.

According to the method, the recording parameters are changed adaptively such that only one respective region of interest is always recorded during a work sequence. The recording of image data is thus adaptively limited to relevant image sections, while the recording of unnecessary image data is avoided. This reduces the volume of the image data to be transmitted and evaluated, reduces the latency time and enables cost-saving solutions in the data transmission architecture. At the same time, the transmitted image data are of high quality since only high-quality and relevant image data are generated. The region of interest is in particular determined in current image data showing the work progress. Based on this current region of interest, image recording parameters are now determined by the control unit for the next recording. The image recording parameters are in particular adaptively determined on the basis of this current region of interest and are thus optimally set to or matched to the current situation and the current region of interest.

According to a third aspect of the invention, the object is satisfied by a system for monitoring and/or controlling a work sequence in a working environment, said system comprising a camera apparatus of the above-explained kind, a working apparatus, in particular a robot, that is configured to perform steps of the work sequence, and a control apparatus that is configured to calculate control parameters for the working apparatus based on the image data generated by the camera apparatus and to transmit said control parameters to the working apparatus. The control apparatus can be an integral part of the camera apparatus or can be arranged separately from the camera apparatus. The control parameters can, for example, comprise coordinates of objects in the working environment.

According to one embodiment of the third aspect of the invention, the control apparatus is configured to calculate the control parameters from the image data generated by the camera apparatus by means of a neural network. This enables a fast and precise calculation of the control parameters from the image data, which speeds up the work sequence and improves its quality.

A fourth aspect of the invention comprises a method for an optimized prediction of image recording parameters of the camera apparatus of the above-explained kind, wherein a computer-generated virtual model of the working environment and the work sequence is created, a virtual image of the sequence of image data is generated, the detection unit detects objects in the virtual image of the sequence of image data and determines a respective region of interest within the virtual working environment on the basis of the objects detected in the image data, the control unit determines a sequence of image recording parameters on the basis of the respective regions of interest determined by the detection unit, and the sequence of image recording parameters is stored and/or transmitted to a memory unit, in particular wherein the sequence of image recording parameters comprises a sequence of cropping parameters that limits the recording of image data by the image sensor to an image section that corresponds to the region of interest.

By means of a virtualization, a digital twin is thus created that is used to predict the best possible parameters. Using the palletizing process as an example, a virtualization of the working environment, of the pallet and of the sensor data can be used to predict which settings of the image recording parameters will deliver the best possible result when setting up or dismantling the pallet. This can, for example, take place geometrically on the basis of the virtualized working environment or using a sensor data simulation. The simulated sensor data can in particular be fed to the same neural network that is used to determine the region of interest in order to improve the image recording parameters.

The invention will be explained only by way of example in the following with reference to the Figures.

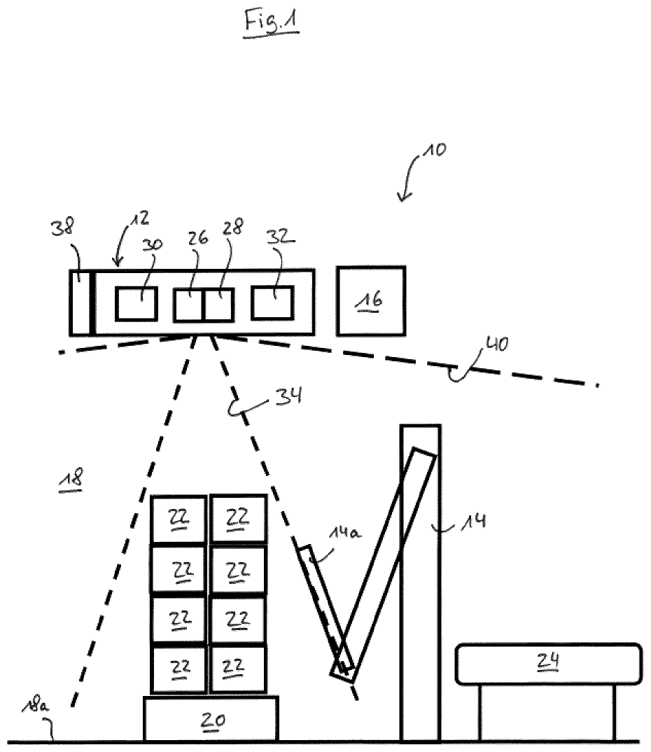

FIG. 1 shows an embodiment of the system according to the invention in a schematic representation at a first point in time of a work sequence;

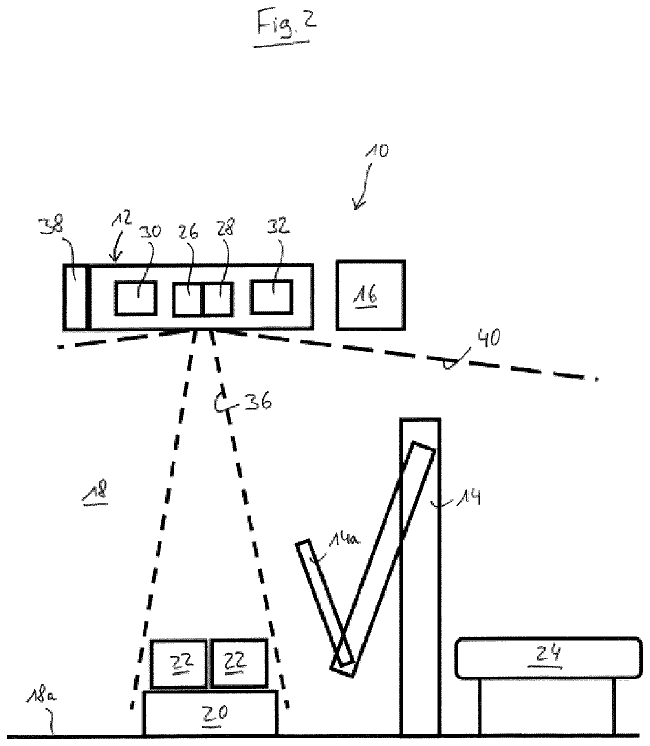

FIG. 2 shows the system of FIG. 1 at a second point in time of the work sequence; and

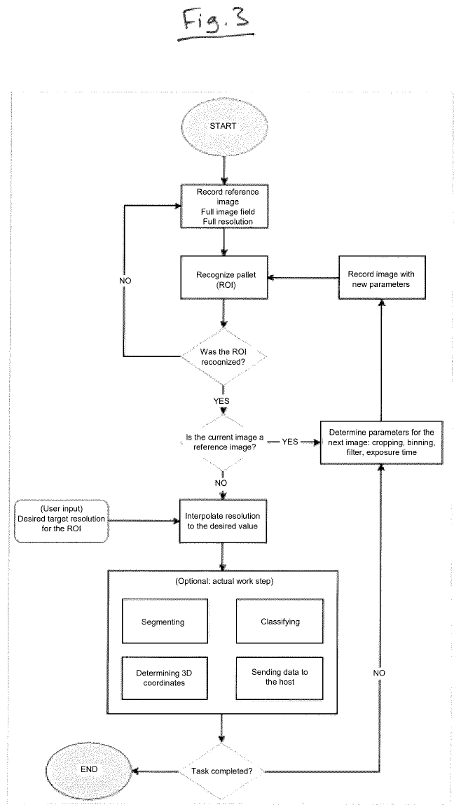

FIG. 3 shows a flowchart of an embodiment of the method according to the invention by means of the system of FIGS. 1 and 2.

FIGS. 1 and 2 show an embodiment of a system 10 according to the invention in schematic representations at a first and a second point in time of a work sequence. The system 10 comprises a camera apparatus 12, a working apparatus 14, shown here schematically as a robot, and a control apparatus 16. The system 10 is located in a hall 18 that forms a working environment. On the floor 18a of the hall 18 there is a pallet 20 that is loaded with goods packages 22 and that is to be unloaded. For this purpose, the goods packages 22 are lifted from the pallet 20 by an arm 14a of the robot 14 and are positioned on a conveyor belt 24. At the early first point in time of the work sequence shown in FIG. 1, there are still many goods packages 22 on the pallet 20. At the later second point in time of the work sequence shown in FIG. 2, further goods packages 22 have already been lifted from the pallet 20 by the robot arm 14a and positioned on the conveyor belt 24.

The camera apparatus 12 is arranged above the pallet 20, for example, on the ceiling of the hall 18 at a height of 4 m.

The camera apparatus 12 includes a first image sensor 26 and a second image sensor 28 that are arranged next to one another and have substantially the same field of view. A plurality of picture elements are arranged in the first image sensor 26 and in the second image sensor 28, respectively. The first image sensor 26 is configured to generate a three-dimensional image of the working environment 18 and can, for example, be a 3D time-of-flight camera or a 3D stereo camera. The second image sensor 26 is configured to generate a two-dimensional image of the working environment 18. The second light sensor 28 can, for example, be a 2D RGB camera. The camera apparatus 12 is configured to record a continuous sequence of image data of at least one region of the working environment 18 by means of the first image sensor 26 and/or the second image sensor 28. For a complete temporal monitoring of the work sequence, the frame rate is here selected such that it is greater than the cycle rate of the work steps of the work sequence, i.e. the gripping of the goods packages 22 on the pallet 20.

The camera apparatus 12 furthermore includes a detection unit 30 and a control unit 32. The detection unit 30 is configured to detect one or more objects in the image data of the first and/or second image sensor 26, 28 and to determine a region of interest 34, 36 on the basis of the objects detected in the image data. For this purpose, the detection unit 30 can include a neural network that, for example, determines an outwardly bounding contour of the objects detected in the image data and uses this contour to determine the respective region of interest 34, 36. To determine the region of interest, the detection unit can treat the image data of the image sensors 26, 28 separately or can combine them with one another to arrive at a more precise determination.

In this respect, the region of interest 34, 36 is that image section in the image data which comprises all the relevant objects detected in the working environment 18 before the next work step and a sufficiently large adjoining marginal region. In the example of the depalletizing shown, the region of interest 24 is thus, from the angle of view of the first and/or second image sensor 26, 28, the entire surface of the pallet 20, of the goods packages 22 on the pallet 20, and of a sufficiently large buffer environment to ensure that all the goods packages 22 located on the pallet 20, i.e. the current load of the pallet 20, are in the relevant image section at all times. During the work process, the region of interest 34, 36 changes continuously. In particular, due to the smaller distance of the goods packages 22 on the pallet 20 from the camera apparatus 12, the region of interest 34 at the early first point in time of the palletizing is larger than the region of interest 36 at the later second point in time of the depalletizing.

The control unit 32 is configured to control and to adaptively change image recording parameters on the basis of the region of interest 34, 36 determined by the detection unit 30. The image recording parameters include a cropping parameter that limits the recording of image data by the image sensor 26, 28 to an image section that corresponds to the respective region of interest 34, 36. The image recording parameters furthermore include a binning parameter that combines a number of adjacent picture elements of the first and/or second image sensor 26, 28, the respective exposure time of the first and/or second image sensor 26, 28, a spatial filter that spatially averages the image data recorded by the first and/or second image sensor 26, 28, and a temporal filter that temporally averages a sequence of image data consecutively recorded by the first and/or second image sensor 26, 28.

The camera apparatus 12 furthermore includes an interface 38 by means of which a desired resolution of the image data to be recorded can be selected and/or input and transmitted to the control unit 32.

The control apparatus 16 is shown here as a separate component, but can also be an integral component of the camera apparatus 12. The control apparatus 16 is configured to calculate control parameters for the robot 14 based on the image data generated by the camera apparatus 12 and to transmit said control parameters to the robot 14. The control parameters, for example, comprise optimal gripping coordinates for gripping one of the goods packages 22 on the pallet 20. For this purpose, the control apparatus 16 has a neural network that takes over tasks such as the segmentation, the classification or the determination of three-dimensional coordinates. The calculated control parameters can be transmitted in a wired or wireless manner to the host of the robot 14.

One embodiment of the method for monitoring and controlling a palletizing process by means of the system 10 of FIGS. 1 and 2 will now be explained with reference to the flowchart of FIG. 3.

At the start of the work sequence, a user enters the desired resolution of the image data to be recorded via the interface 38 of the camera apparatus 12. The first and the second image sensor 26, 28 then each record the entire region 40 of the working environment 18 with a maximum resolution and store the recordings as a reference image in each case. The maximum resolution in each case corresponds to the best possible resolution of the image sensors 26, 28 of the camera apparatus 12. The reference image corresponds to a complete and accurate image of the working environment 18 and provides a complete overview of the available space and the apparatus 14, 20, 22, 24 located therein. It is ensured by the reference image that no relevant image section is located outside the recorded region. The reference image serves to check and define the working environment 18 at the start of the work sequence.

Objects are now detected in the reference image by the neural network of the detection unit 30 and a region of interest (ROI) within the working environment 18 is determined on the basis of the objects detected in the image data. If no region of interest could be determined, the steps of recording the reference image and determining the ROI are repeated until an ROI could be determined. Based on the determined region of interest, image recording parameters are now determined by the control unit 32. The image recording parameters include the cropping parameter, the binning parameter, the exposure time and the spatial and temporal filter.

After the control unit 32 has adaptively adjusted the image recording parameters to the region of interest, new image data that are adapted to the current region of interest are recorded by the image sensors 26, 28. These new image data are the first image data that are used by the control apparatus 16 during the work sequence to determine control parameters for the robot 14. For an optimal mode of operation of the neural network of the control apparatus 16, the image data are, however, first interpolated to the desired resolution entered by the user. In this respect, the desired resolution ideally corresponds to the resolution of the image data that were used to train the neural network. The neural network analyzes the first image data with respect to tasks such as the segmentation, the classification or the determination of three-dimensional coordinates and determines control parameters for the robot 14 therefrom. The control parameters are transmitted in a wired or wireless manner to the host of the robot 14 that then performs the actual work step and removes a goods package 22 from the pallet 20.

In the next step, the first image data are used to determine a current region of interest. The image recording parameters are adaptively adjusted to the region of interest and new image data are recorded. The new image data are interpolated to the desired resolution again and are fed to the neural network of the control apparatus 16. The control parameters determined on the basis of the new image data are transmitted to the host of the robot 14 that again performs the corresponding work steps.

The method steps are repeated until the task has been completed and all the goods packages 22 have been removed from the pallet 20.

According to the method according to the invention, the image recording parameters are adaptively changed such that only one respective region of interest 34, 36 is always recorded during a work sequence. The recording of image data is thus adaptively limited to relevant image sections 34, 36, while a recording of unnecessary image data is avoided. This reduces the volume of the image data to be transmitted and evaluated, reduces the latency time and enables cost-saving solutions in the data transmission architecture. At the same time, the transmitted image data are of high quality since only high-quality and relevant image data are generated. The region of interest 34, 36 is in particular determined in current image data showing the work progress. Based on this current region of interest 34, 36, image recording parameters for the next recording are now determined by the control unit 32. The image recording parameters are in particular adaptively determined on the basis of this current region of interest 34, 36 and are thus optimally set to or matched to the current situation and the current region of interest 34, 36.

A faster, more accurate and more cost-effective monitoring and/or control of the work sequence is thus made possible by the method according to the invention.

### Reference Numerals

10 system
12 camera apparatus
14 robot
14a robot arm
16 control apparatus
18 hall
18a floor of the hall
20 pallet
22 goods package
24 conveyor belt
26 first image sensor
28 second image sensor
30 detection unit
32 control unit
34 region of interest
36 region of interest
38 interface
40 entire region of the working environment

1-14. (canceled)

15. A camera apparatus for monitoring and/or controlling a work sequence in a working environment, wherein the camera apparatus comprises:
at least one image sensor in which a plurality of picture elements are arranged and which is configured to record a sequence of image data of at least one region of the working environment, wherein the recording of the image data takes place during the work sequence,
at least one detection unit that is configured to detect one or more objects in the image data,
at least one control unit that is configured to control image recording parameters of the image sensor,
wherein the detection unit is configured to determine a region of interest on the basis of the objects detected in the image data,
wherein the control unit is configured to control at least one image recording parameter on the basis of the region of interest determined by the detection unit, and wherein the at least one image recording parameter comprises a cropping parameter that limits the recording of image data by the image sensor to an image section that corresponds to the region of interest.

16. The camera apparatus according to claim 15, wherein the control unit is configured to determine the at least one image recording parameter for the next recording of image data on the basis of the region of interest determined by the detection unit in the image data of the previous recording.

17. The camera apparatus according to claim 15, wherein the resolution of the image data is constant and can be selected and/or preset between a minimum value and a maximum value.

18. The camera apparatus according to claim 15, wherein the image recording parameters comprise a binning parameter that summarizes a number of adjacent picture elements of the image sensor.

19. The camera apparatus according to claim 15, wherein the image recording parameters comprise a spatial filter parameter that spatially averages the image data recorded by the image sensor.

20. The camera apparatus according to claim 15, wherein the image recording parameters comprise a temporal filter parameter that temporally averages a sequence of image data consecutively recorded by the image sensor.

21. The camera apparatus according to claim 15, wherein the image recording parameters comprise the exposure time for the recording of the image data by the image sensor.

22. The camera apparatus according to claim 15, wherein the detection unit comprises a neural network that is configured to determine a region of interest on the basis of the objects detected in the image data.

23. A method for monitoring and/or controlling a work sequence in a working environment by a camera apparatus, wherein the camera apparatus comprises at least one image sensor, at least one detection unit and at least one control unit that is configured to control image recording parameters of the image sensor, wherein
a plurality of picture elements are arranged in the image sensor and the image sensor records a sequence of image data of at least one region of the working environment, the detection unit detects objects in the image data and determines a region of interest within the working environment on the basis of the objects detected in the image data, the control unit controls at least one image recording parameter on the basis of the region of interest determined by the detection unit, wherein the at least one image recording parameter comprises a cropping parameter that limits the recording of image data by the image sensor to an image section that corresponds to the region of interest.

24. The method according to claim 23, wherein the control unit determines image recording parameters for the next recording of image data on the basis of the region of interest determined by the detection unit in the image data of the previous recording.

25. The method according to claim 23, wherein the image sensor records the entire region of the working environment with a maximum resolution at the start of the method and stores the recording as a reference image.

26. A system for monitoring and/or controlling a work sequence in a working environment, said system comprising a camera apparatus for monitoring and/or controlling a work sequence in a working environment, wherein the camera apparatus comprises:
at least one image sensor in which a plurality of picture elements are arranged and which is configured to record a sequence of image data of at least one region of the working environment, wherein the recording of the image data takes place during the work sequence,
at least one detection unit that is configured to detect one or more objects in the image data,
at least one control unit that is configured to control image recording parameters of the image sensor,
wherein the detection unit is configured to determine a region of interest on the basis of the objects detected in the image data,
wherein the control unit is configured to control at least one image recording parameter on the basis of the region of interest determined by the detection unit, and wherein the at least one image recording parameter comprises a cropping parameter that limits the recording of image data by the image sensor to an image section that corresponds to the region of interest, said system further comprising a working apparatus, that is configured to perform steps of the work sequence, and a control apparatus that is configured to calculate control parameters for the working apparatus based on the image data generated by the camera apparatus and to transmit said control parameters to the working apparatus.

27. The system according to claim 26, wherein the control apparatus is configured to calculate the control parameters from the image data generated by the camera apparatus by means of a neural network.

28. A method for an optimized prediction of image recording parameters of a camera apparatus for monitoring and/or controlling a work sequence in a working environment,
wherein the camera apparatus comprises:
at least one image sensor in which a plurality of picture elements are arranged and which is configured to record a sequence of image data of at least one region of the working environment, wherein the recording of the image data takes place during the work sequence,
at least one detection unit that is configured to detect one or more objects in the image data,
at least one control unit that is configured to control image recording parameters of the image sensor,
wherein the detection unit is configured to determine a region of interest on the basis of the objects detected in the image data,
wherein the control unit is configured to control at least one image recording parameter on the basis of the region of interest determined by the detection unit, and wherein the at least one image recording parameter comprises a cropping parameter that limits the recording of image data by the image sensor to an image section that corresponds to the region of interest, wherein
a computer-generated virtual model of the working environment and the work sequence is created,
a virtual image of the sequence of image data is generated,
the detection unit detects objects in the virtual image of the sequence of image data and determines a respective region of interest within the virtual working environment on the basis of the objects detected in the image data,
the control unit determines a sequence of image recording parameters on the basis of the respective regions of interest determined by the detection unit, and the sequence of image recording parameters is stored and/or transmitted to a computer unit.

29. The camera apparatus according to claim 15, wherein the recording of the image data takes place continuously at a presettable or preset frame rate.

30. The camera apparatus according to claim 15, wherein the control unit is configured to adaptively change said at least one image recording parameter on the basis of the region of interest determined by the detection unit.

31. The camera apparatus according to claim 16, wherein the control unit is configured to adaptively change the at least one image recording parameter for the next recording of image data on the basis of the region of interest determined by the detection unit in the image data of the previous recording.

32. The method according to claim 23, wherein
the image sensor records a sequence of image data of at least one region of the working environment continuously at a presettable or preset frame rate.

33. The method according to claim 23, wherein the control unit adaptively changes said at least one image recording parameter on the basis of the region of interest determined by the detection unit.

34. The method according to claim 24, wherein the control unit adaptively changes the image recording parameters for the next recording of image data on the basis of the region of interest determined by the detection unit in the image data of the previous recording.

35. The system according to claim 26, wherein the working apparatus is a robot.

36. The method according to claim 28, wherein the sequence of image recording parameters comprises a sequence of cropping parameters that limits the recording of image data by the image sensor to an image section that corresponds to the region of interest.
